(19) United States
(12) Patent Application Publication
(10) Pub. No.: US 2017/0124695 A1
(43) Pub. Date: May 4, 2017

(54) DATA PROCESSING APPARATUS

(71) Applicant: Samsung Electronics Co., Ltd., Suwon-si (KR)

(72) Inventors: Sangok SEOK, Seongnam-si (KR); Il-Hyoung LEE, Daejeon (KR); Byeong-Hwan JEON, Yongin-si (KR)

(73) Assignee: Samsung Electronics Co., Ltd., Suwon-si (KR)

(21) Appl. No.: 15/211,331

(22) Filed: Jul. 15, 2016

(30) Foreign Application Priority Data
Oct. 29, 2015 (KR) 10-2015-0151184

(51) Int. Cl. G06T 7/00; G06T 1/20; H04N 5/225

(52) U.S. Cl. CPC G06T 7/0004; H04N 5/2258; G06T 7/0081; G06T 1/20; G06T 2207/30148; G06T 2207/10141

(57) ABSTRACT

Provided are a data processing apparatus and a substrate inspection method. The data processing apparatus includes a first sensing unit which generates first data about a target, a second sensing unit which generates second data about the target, a splitter unit which receives and synchronizes the first data and the second data and outputs m pieces of copied data by copying the synchronized data, and a processing unit which receives and processes any one of the m pieces of copied data, wherein the second data has a time difference with the first data, and m is a natural number of two or more.

This U.S. non-provisional application claims the benefit of priority under 35 U.S.C. §119 to Korean Patent Application No. 10-2015-0151184, filed on Oct. 29, 2015 in the Korean Intellectual Property Office (KIPO), the disclosure of which is incorporated by reference in its entirety herein.

### BACKGROUND

1. Technical Field

The present inventive concepts relate to a data processing apparatus.

2. Description of the Related Art

High processor performance is required to support three-dimensional (3D) simulation, media file streaming, enhanced security standards, sophisticated user interfaces, improved database processing, etc. However, there are limitations in supporting these functions using a single processor. To solve this problem, multiple processors are used.

In the conventional art, multiple processors sequentially process data in a distributed manner using a daisy chained topology. In this case, however, data processing time is relatively increased. In addition, since data is transmitted in series and processed by the multiple processors, when an error occurs in one of the processors, the other processors connected to the processor are made to stop their data processing operations.

### SUMMARY

Aspects of the present inventive concepts provide a data processing apparatus which improves data processing speed by simultaneously processing data in parallel in a distributed manner.

Aspects of the present inventive concepts also provide a data processing apparatus including a topology where in the event when an error occurs in one or more processing nodes, the other processing nodes operate normally.

Aspects of the present inventive concepts also provide a data processing apparatus which, when processing data by dividing the data, has an improved ability to detect defects in each boundary region of the divided data.

However, aspects of the present inventive concepts are not restricted to the ones set forth herein. The above and other aspects of the present inventive concepts will become more apparent to one of ordinary skill in the art to which the present inventive concepts pertains by referencing the detailed description of the present inventive concepts given below.

According to some example embodiments of the present inventive concepts, there is provided a data processing apparatus. In at least one example embodiment, the data processing apparatus includes a first sensor configured to generate first data about a target, a second sensor configured to generate second data about the target, the second data having a time difference from the first data, a splitter configured to receive and synchronize the first data and the second data, and output m pieces of copied data by copying the synchronized data, a processor configured to receive and process any one of the m pieces of copied data, and m is a natural number of 2 or more.

In at least one example embodiment, the apparatus may include m output buses connecting the splitter and the processor, and wherein the m pieces of copied data are transmitted simultaneously through the in output buses.

In at least one example embodiment, the processor may be configured to process data corresponding to 1/m-th of any one of the m pieces of copied data.

In at least one example embodiment, each of the first data and the second data may include information corresponding to any one of n regions into which the target is divided, where n is a natural number of 2 or more.

In at least one example embodiment, the first data and the second data may comprise information corresponding to a same region of the target.

In at least one example embodiment, the splitter may comprise a receiver buffer, and the receiver buffer may be configured to store the first data and the second data, and synchronize the stored first data and the stored second data.

In at least one example embodiment, the receiver buffer may be configured to store the first data and the second data as packets.

In at least one example embodiment, the splitter may further include a control block configured to set a size of the receiver buffer.

In at least one example embodiment, the splitter may further include a transmitter buffer configured to store the synchronized data.

According to some example embodiments of the present inventive concepts, there is provided a data processing apparatus. In at least one example embodiment, the data processing apparatus includes a first sensor configured to generate first partial data and second partial data regarding a target, a second sensor configured to generate third partial data and fourth partial data regarding the target, a first splitter configured to receive the first partial data and the third partial data and output first synchronized data by synchronizing the first partial data and the third partial data, a second splitter configured to receive the second partial data and the fourth partial data, and output second synchronized data by synchronizing the second partial data and the fourth partial data, a first processor configured to receive and process the first synchronized data, a second processor configured to receive and process the second synchronized data, and the third partial data has a time difference from the first partial data, and the fourth partial data has a time difference from the second partial data.

In at least one example embodiment, each of the first partial data and the second partial data may include information corresponding to any one of n regions into which the target is divided, where n is a natural number of 2 or more.

In at least one example embodiment, the first partial data and the second partial data may include information corresponding to different regions of the target.

In at least one example embodiment, the first partial data may include information corresponding to a first boundary region, the second partial data comprises information corresponding to a second boundary region, and the first boundary region and the second boundary region overlap each other.

In at least one example embodiment, a speed at which the first splitter may be configured to output the first synchronized data is adjusted based on a speed at which the first splitter is configured to receive the first partial data and the third partial data.

In at least one example embodiment, the first splitter may be configured to copy the first synchronized data and output the copied data.

In at least one example embodiment, the copied data may be provided in a plurality of pieces, and the pieces of copied data are output in parallel.

According to some example embodiment of the present inventive concepts, there is provided a data processing apparatus. In at least one example embodiment, the data processing apparatus includes a plurality of sensors, a plurality of splitters configured to receive first through n-th pieces of partial data from the plurality of sensors, each piece of the partial data comprising a plurality of data packets, generate first through n-th pieces of synchronized data by synchronizing the plurality of data packets, and generate first through m-th pieces of copied data for each of the first through n-th pieces of synchronized data, and a processor array including an m×n matrix of processors, the processing array configured to receive the first through m-th pieces of copied data in parallel and process the first through m-th pieces of copied data, and wherein n is a natural number of 2 or more and m is a natural number of 2 or more.

In at least one example embodiment, each of the first through n-th pieces of partial data may include information corresponding to a boundary region which overlaps a boundary region of another piece of the partial data.

In at least one example embodiment, in processors may be arranged in a first column of the processor array and may be each configured to receive any one of the first through math pieces of copied data.

In at least one example embodiment, the first through math pieces of copied data may comprise the same information.

In at least one example embodiment, each of the in processors may be configured to process any one of the first through m-th pieces of copied data.

In at least one example embodiment, n processors may be arranged in a first row of the processor array and may be each configured to receive any one of the first through n-th pieces of partial data.

In at least one example embodiment, the first through nth pieces of partial data may include different information.

According to some example embodiment of the present inventive concepts, there is provided a data processing apparatus. In at least one example embodiment, the data processing apparatus includes a sensor array comprising at least a first sensor and a second sensor, a splitter configured to receive and synchronize first data and second data obtained respectively by the first sensor and the second sensor, generate first through n-th pieces of partial data by dividing the synchronized data, generate first through m-th pieces of copied data by copying the first piece of partial data, output the first through m-th pieces of copied data, and a processor array which comprises first through math processing nodes each configured to receive the first through math pieces of copied data in parallel and process the first through math pieces of copied data, wherein n is a natural number of 2 or more, and in is a natural number of 2 or more.

In at least one example embodiment, in output buses may connect the splitter and the first through m-th processing nodes, and wherein the first through m-th pieces of copied data are transmitted simultaneously through the in output buses.

In at least one example embodiment, the processor array may include a plurality of processing nodes arranged in an m×n matrix.

In at least one example embodiment, for the processing nodes, each of in processors arranged in a first column of the processor array may be each configured to process any one of the first through m-th pieces of copied data.

In at least one example embodiment, for of the processing nodes, in processors may be arranged in a first column of the processor array and may be each configured to receive the first through m-th pieces of copied data and process the first through m-th pieces of copied data using in different algorithms.

In least one example embodiment, each of the first through n-th pieces of partial data may include information corresponding to a boundary region which overlaps a boundary region of another piece of partial data.

In at least one example embodiment, the splitter may include a receiver buffer, the receiver buffer may be configured to store the first data and the second data, and synchronize the stored first data and the stored second data.

In at least one example embodiment, the receiver buffer may be configured to store the first data and the second data in packets.

In at least one example embodiment, the splitter may include a transmitter buffer configured to store the synchronized data and the first through n-th pieces of partial data.

In at least one example embodiment, the splitter may include a control block configured to set a size of the receiver buffer.

According to some example embodiment of the present inventive concepts, there is provided a substrate inspection method. In at least one example embodiment, the method includes generating first image data about a pattern on a substrate using a first image capturing unit, generating second image data about the pattern using a second image capturing unit, synchronizing the first image data and the second image data, generating m pieces of copied data by copying the synchronized data, transmitting the m pieces of copied data to m processors simultaneously, and processing the In pieces of copied data using the m processors, and wherein m is a natural number of 2 or more.

In at least one example embodiment, each of the first and second image capturing units may include a time delay integration (TDI) camera.

In at least one example embodiment, the first image data and the second image data may have a time difference.

In at least one example embodiment, each of the first image data and the second image data may include information corresponding to the same region.

According to some example embodiment of the present inventive concepts, there is provided a data processing apparatus. In at least one example embodiment, the data processing apparatus includes a plurality of image sensors each configured to capture image data of at least one region of a substrate, a plurality of splitters each configured to receive the captured image data from each of the plurality of image sensors, synchronize each of the plurality of received image data into a single synchronized image, split the synchronized image data into a plurality of split image data, the split image data including a portion of the synchronized image data, generate a plurality of sets of copied image data, each of the sets of copied image data including copies of each of the plurality of split image data, and output the plurality of sets of copied image data in parallel, and a plurality of processors each configured to receive at least one of the output plurality of sets of copied image data and process the received set of copied image data.

In at least one example embodiment, the substrate may be divided into a plurality of regions, each of the captured image data may include image data related to a border region between at least two regions of the divided substrate, and the processing of the received copied image data may include detecting detects in the substrate by analyzing the received set of copied image data.

In at least one example embodiment, the plurality of processors may be a processor array arranged in a first number of rows and a second number of columns, the splitting of the synchronized image data may include splitting the synchronized image data into a number of split image data corresponding to the first number of rows, and the copying of the plurality of the split image data may include copying the split image data a number of times corresponding to the second number of columns.

In at least one example embodiment, each of the plurality of image sensors may be configured to use separate image capturing settings, and capture image data of a same region of the plurality of regions separate times.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are necessarily to scale, emphasis instead being placed upon illustrating principles of inventive concepts. In the drawings:

FIG. 1 is a block diagram of a data processing apparatus according to at least one example embodiment of the present inventive concepts;

FIG. 2 is a diagram illustrating divided image data according to at least one example embodiment of the present inventive concepts;

FIG. 3 is a schematic block diagram of a splitter unit according to at least one example embodiment of the present inventive concepts;

FIG. 4 is a schematic block diagram of a splitter unit according to at least one example embodiment of the present inventive concepts;

FIG. 5 is a block diagram of a data processing apparatus according to at east one example embodiment of the present inventive concepts;

FIG. 6 is a block diagram of a data processing apparatus according to at least one example embodiment of the present inventive concepts;

FIG. 7 is a block diagram of a data processing apparatus according to at least one example embodiment of the present inventive concepts;

FIG. 8 is a block diagram of a data processing apparatus according to at least one example embodiment of the present inventive concepts;

FIG. 9 is a block diagram of a system-on-chip (SoC) system employing a data processing apparatus according to at least one example embodiment of the present inventive concepts;

FIG. 10 is a block diagram of a wireless communication device employing a data processing apparatus according to at least one example embodiment of the present inventive concepts; and

FIG. 11 is a block diagram of an electronic system including a data processing apparatus according to at least one example embodiment of the present inventive concepts.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e,g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments,

Spatially relative terms, such as “beneath,” “below,” “lower,” “above,” “upper” and the like, may be used herein for ease of description to describe one element or feature's relationship to another element(s) or feature(s) as illustrated in the figures. It will be understood to another element(s) or feature(s) as illustrated in the figures. It will be the device in use or operation in addition to the orientation depicted in the figures. For example, if the device in the figures is turned over elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

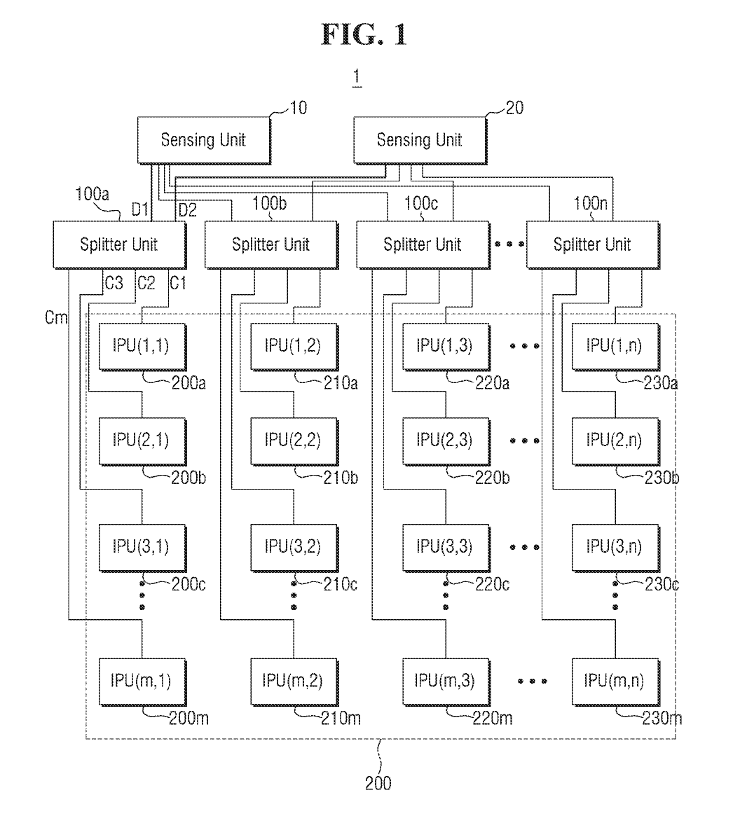

Hereinafter, data processing apparatuses according to various example embodiments of the present inventive concepts will be described with reference to FIGS. 1 through 8.

The data processing apparatuses according to at least one example embodiment of the present inventive concepts includes a system for processing high-volume, high-speed data in real time. Specifically, each of the data processing apparatuses according to at least one example embodiment of the present inventive concepts may include a field programmable gate array (FPGA), but is not limited thereto and may include other types of specialized, custom, and/or programmable processing devices. An FPGA is an integrated circuit made for final verification of operation and performance of pre-designed hardware just before producing the hardware in the form of a semiconductor. That is, the FPGA is a kind of non-memory semiconductor and is a semiconductor whose circuit may he redesigned a number of times unlike a general semiconductor whose circuit is not modifiable. Since the FPGA can be programmed according to a user's needs, it corresponds to an ASIC.

The data processing apparatuses according to at least one example embodiments of the present inventive concepts may employ various types of algorithms and provide additional functions modified variously according to the hardware made to order.

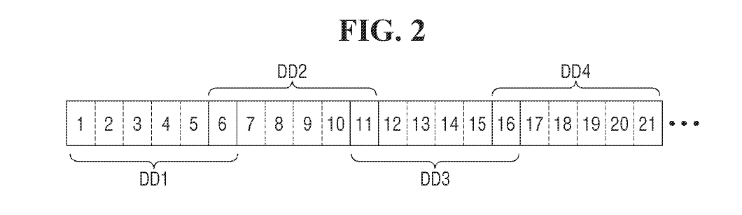

FIG. 1 is a block diagram of a data processing apparatus 1 according to at least one example embodiment of the present inventive concepts. FIG. 2 is a diagram illustrating divided image data according to at least one example embodiment of the present inventive concepts.

Referring to FIG. 1, the data processing apparatus 1 includes a plurality of sensors, e.g., first sensing unit 10 and second sensing unit 20, a plurality of splitters, e.g., first through n^{th} splitter units 100a through 100n, and a processor array, e.g., processing unit array 200.

For example, each of the first sensing unit 10 and the second sensing unit 20 (e.g., first sensor and second sensor) may include a photo sensor. For the same image region, the first sensing unit 10 may collect optical data, and the second sensing unit 20 may collect optical data after a desired period of time, or at desired intervals of time.

For example, the data processing apparatus 1 may be used to inspect a pattern on a substrate. Each of the first sensing unit 10 and the second sensing unit 20 may be a time delay integration (TDI) camera. First image data including a pattern on a substrate (e.g., a semiconductor wafer, a mask, a reticle, etc.) may be generated using the first sensing unit 10, and second image data including the pattern on the substrate (e.g., the semiconductor wafer, the mask, the reticle, etc.) may be generated using the second sensing unit 20. Here, the first image data and the second image data may include information corresponding to the same region on the substrate and may be generated by capturing the same region at different times.

If image data corresponding to and/or including a pattern on a substrate is generated and processed using a plurality of TDI cameras as described above, a pattern image of the same pattern can be generated in various aspects by setting different detection conditions for each of the TDI cameras. For example, a pattern may be captured by setting different filter conditions, different wavelength conditions, etc., for each of the TIN cameras. In other words, each of the TIN cameras of a plurality of TDI cameras may be configured to have one or more settings related to the camera (e.g., image capturing settings) that is not the same as another TDI camera of the plurality of TDI cameras. Then, a plurality of pieces of captured image data may be synchronized to produce one image. Accordingly, a pattern image similar to the actual shape of the pattern is generated.

In addition, generating a pattern image by synchronizing a plurality of pieces of image data obtained using a plurality of TDI cameras may increase the captured image's resolution. Experiments conducted according to one or more of the example embodiments of the inventive concepts presented herein have shown that the captured image resolution may be increased by approximately 1.4 times over conventional image capture techniques/apparatuses.

The first sensing unit 10 may include an image sensor, a sound sensor, etc. in addition to the photo sensor. The second sensing unit 20 may also include an image sensor, a sound sensor, etc., in addition to the photo sensor.

According to some of the example embodiments of the present inventive concepts, the first sensing unit 10 may be a sensor array including a plurality of sensors. In addition, the second sensing unit 20 may also be a sensor array including a plurality of sensors, but is not limited thereto.

Each of the first sensing unit 10 and the second sensing unit 20 may include a plurality of photo sensors and may be used to thoroughly inspect a substrate, such as a semiconductor wafer, a mask, a reticle, etc.

The first sensing unit 10 may generate first data D1 corresponding to and/or including a target T, and the second sensing unit 20 may generate second data D2 corresponding to and/or including the target T. The second data D2 may have a time difference with the first data D1, or in other words the second data D2 is data captured at a different time than the first data D1. That is, the first sensing unit 10 and the second sensing unit 20 may be separated from each other and perform sensing operations on the same region of the same target T at different times.

Each of the first data D1 and the second data D2 may include information about one or more regions of a plurality of regions of the target T. Referring to FIG. 2, a plurality of partial data is generated, for example first partial data DD1, second partial data DD2 third partial data DD3, fourth partial data DD4, etc. After the target T is divided into a plurality of regions, the first sensing unit 10 generates the first data D1 by sensing one of the regions, that is, generating data corresponding to and/or including the first partial data DD1. In addition, the second sensing unit 20 generates the second data D2 by sensing one of the regions, that is, generating data corresponding to and/or including the first partial data DD1. That is, the first sensing unit 10 and the second sensing unit 20 perform sensing operations at different times but generate data including information corresponding to and/or including the same region. For example, the first sensing unit 10 generates a plurality of pieces of data after performing a sensing operation on every region of the target T, and the second sensing unit 20 generates a plurality of pieces of data corresponding to the pieces of data generated by the first sensing unit 10 by performing a sensing operation on every region of the target T as well at a different time than the first sensing unit 10.

For example, the first partial data DD1 may include information corresponding to any one of n regions (where n is a natural number of 2 or more) into which the target T is divided (e.g., the target T is divided into n regions), the second partial data DD2 may include information corresponding to any one of the n regions into which the target T is divided, the third partial data DD3 may include information corresponding to any one of the n regions into which the target T is divided, and the fourth partial data DD4 may include information corresponding to any one of the n regions into which the target T is divided. Each of the first partial data DD1, the second partial data DD2, the third partial data DD3 and the fourth partial data DD3, etc. includes information corresponding to a different region u each of the partial data corresponds to a separate region).

The first partial data DD1 may overlap the second partial data DD2 in a boundary region between the first partial data DD1 and the second partial data DD2. In addition, the second partial data DD2 may overlap each of the first partial data DD1 and the third partial data DD3 in a boundary region between the two partial data. Further, the third partial data DD3 may overlap each of the second partial data DD2 and the fourth partial data DD4 in a boundary region between the two.

Referring to FIG. 2, information included in data transmitted through channel 6 of the first sensing unit 10 or the second sensing unit 20 may be included in one or both of the first partial data DD1 and the second partial data DD2, or in other words, the data corresponding to position 6 of FIG. 2 may be received from either the first sensing unit 10 and/or second sensing unit 20 and may be included in one or both of the first partial data DD1 and the second partial data DD2. In addition, information included in data transmitted through channel 11 may be included in one or both of the second partial data DD2 and the third partial data DD3. Further, information included in data transmitted through channel 16 may be included in one or both of the third partial data DD3 and the fourth partial data DD4.

If each of the first sensing unit 10 and the second sensing unit 20 includes an image sensor array, its defect detect ability (e.g., ability to detect defects) in each boundary region of a divided image during the process of generating divided image data may be improved. For example, if the first partial data DD1, the second partial data DD2, the third partial data DD3, and the fourth partial data DD4, etc., do not overlap each other in the boundary region therebetween, only a part of a defect existing in a boundary region of the divided image is included in the divided image data. Therefore, this may not be recognized as a defect. However, when the first through fourth partial data DD1 through DD4 overlap each other in the boundary region, complete information is obtained from each boundary region of the divided image and therefore the defect is recognized.

According to at least one example embodiment, each of the first through n^{th} splitter units 100a through 100n may receive a plurality of pieces of data, synchronize the received pieces of data, and output m pieces of copied data (where m is a natural number of 2 or more) in parallel by copying the synchronized pieces of data. The first through n^{th} splitter units 100a through 100n may perform the same function and thus will be described based on the first splitter unit 100a.

The first splitter unit 100a may receive the first data D1 from the first sensing unit 10 and the second data D2 from the second sensing unit 20 and synchronize the first data D1 and the second data D2. Since the first data D1 and the second data D2 have a time difference, the first splitter unit 100a may synchronize the first data D1 and the second data D2 using a reference clock, thereby generating first synchronized data SD1. The first splitter unit 100a may generate m pieces of copied data C1 through Cm by copying the first synchronized data SD1. The in pieces of copied data C1 through Cm may each include the same information.

Like the first splitter unit 100a, each of the second through n^{th} splitter units 100b through 100n may generate in pieces of copied data by performing synchronization and copying operations.

That is, the first splitter unit 100a may gene the m pieces of copied data C1 through Cm including information corresponding to the first partial data DD1, the second splitter unit 100b may generate in pieces of copied data including information corresponding to the second partial data DD2, and the third splitter unit 100c may generate in pieces of copied data including information corresponding to the third partial data DD3, etc. The copied data generated in this way may be provided to the processing unit array (or processor array) 200, the processing unit array 200 including a plurality of processing nodes, and processed by one or more of the plurality of processing nodes of the processing unit array 200. A plurality of processing nodes arranged in a column direction (e.g., a vertical direction) of the processing unit array 200 may receive the same data. Then, each of the processing nodes may process 1/m^{th} of the received data. Each of the plurality of processing nodes arranged in a row direction (a horizontal direction) of the processing unit array 200 may also receive and process partial data.

Specifically, the processing unit array 200 may be in an m×n matrix and receive and process copied data. For example, the processing unit array 200 may include a plurality of processing nodes, and an operation device which can perform a data processing operation may be included in each of the processing nodes. First through m^{th} processing units 200a through 200m are disposed in a first column of the processing unit array 200, etc.

Each of the first through m^{th} processing units 200a through 200m may receive any one of the m pieces of copied data C1 through Cm and process 1/m^{th} of the received piece of copied data, thereby improving the data processing speed. Here, m output buses may be connected in parallel to each other between the first splitter unit 100a and the first through m^{th} processing units 200a through 200m, and the m pieces of copied data C1 through Cm may be transmitted simultaneously through the in output buses. This arrangement is called a multiple tree topology.

The data processing apparatus according to at least one example embodiment of the present inventive concepts may simultaneously process a plurality of pieces of coped data in parallel in a distributed manner using the multiple tree topology, thereby improving the data processing speed. Since the data is processed in parallel (or in other words, the same image is processed by the plurality of processing nodes simultaneously), even if an error occurs in one processing unit included in any one of the plurality of processing nodes, processing units included in the other processing nodes can still perform data processing, thus enabling the data processing apparatus to operate normally. In addition, since a plurality of pieces of partial data overlap each other in a boundary region therebetween, complete information is obtained from each boundary region of a divided image. Also, since a plurality of pieces of unsynchronized high-volume, high-speed data are synchronized, a plurality of pieces of source data is processed more efficiently using one or more of the example embodiments of the present inventive concepts.

Likewise, m output buses may be connected in parallel to each other between a plurality of processing units 210a through 210m arranged in a second column of the processing unit array 200 and the second splitter unit 100b. The m output buses may be connected in parallel to each other between a plurality of processing units 220a through 220m arranged in a third column of the processing unit array 200 and the third splitter unit 100c. And m output buses may be connected in parallel to each other between a plurality of processing units 230a through 230m disposed in an n^{th} column of the processing unit array 200 and the n^{th} splitter unit 100n to distribute a plurality of pieces of copied data in parallel.

The processing unit array 200 may simultaneously receive a plurality of pieces of copied data in parallel in a distributed manner through output buses connected in parallel to each of the first through n^{th} splitter units 100a through 100n and process the received pieces of copied data in parallel in a distributed manner.

The processing unit array 200 includes a plurality of processing units arranged in an m×n matrix. An algorithm for determining the value of m and n will now be described.

For example, assume that the number of sensing units is two, the number of data output channels connected to each sensing unit is t, the data output speed of each channel is c Gbps, the speed at which data is input to a processing unit of each processing node is g Gbps, and the number of channels through which data is input to the processing unit of each processing node is f.

In the data processing apparatus 1 designed as described above with reference to FIG. 1, the following equation should be satisfied:

g/c>f [Equation 1]

Therefore, each sensing unit is connected to each processing node by f/2 channels.

In addition, assuming that each processing node has a data processing capacity of i Gbps, the value of m should he determined to satisfy:

m>c×f/I [Equation 2]

That is, the value of rows of the processing unit array 200 should be determined according to [Equation 2]. In addition, each of the processing units receives the same copied data and processes 1/m^{th} of the received copied data.

As illustrated in FIG. 2, when data is processed in a distributed manner by dividing the data into a plurality of pieces that overlap each other in a boundary region by data corresponding to one channel, the following equation should be satisfied:

(f/2−1)×n+1>t [Equation 3]

Additionally, the following equation is satisfied:

n>(t−1)/(f/2−1) [Equation 4]

The value of n is determined according to [Equation 4], and output data of a sensing unit is divided into n pieces, and the n pieces may be transmitted to a plurality of processing nodes disposed in each row of the processing unit array 200.

Referring back to FIG. 1, in the overall operation of the data processing apparatus 1, high-volume, high-speed data is output from a plurality of sensing units (e.g., the first sensing unit 10 and the second sensing unit 20) through a plurality of data channels. Here, each of the sensing units may be a sensor array including a plurality of sensors, and the sensors may be image sensors configured to output high-volume, high-speed image data. Depending on the settings for the operation of the data processing apparatus 1, a data synchronization error between the image sensor arrays may occur in more than thousands of the data packets. Data output from each of the sensor arrays may be transmitted to a plurality of splitter units (e.g., the first through n^{th} splitter units 100a through 100n) through high-speed communication buses.

Here, the splitter units may be FPGA splitters according to at least one example embodiment of the present inventive concepts, but are not limited thereto. Each of the FPGA splitters receives divided image data from the sensor arrays. Each of the FPGA splitters stores the image data in a high-capacity buffer, synchronizes a plurality of pieces of image data, copies the synchronized pieces of image data, and outputs the copied pieces of image data to an image processing node matrix (e.g., the processing unit array 200) at the same speed as the input speed of the input data. A processing unit disposed in each image processing node processes a desired (or alternatively, predetermined) image region and transmits the processing result to a main computer.

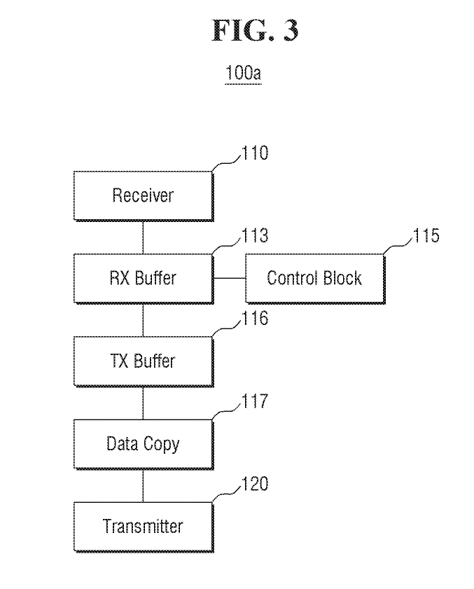

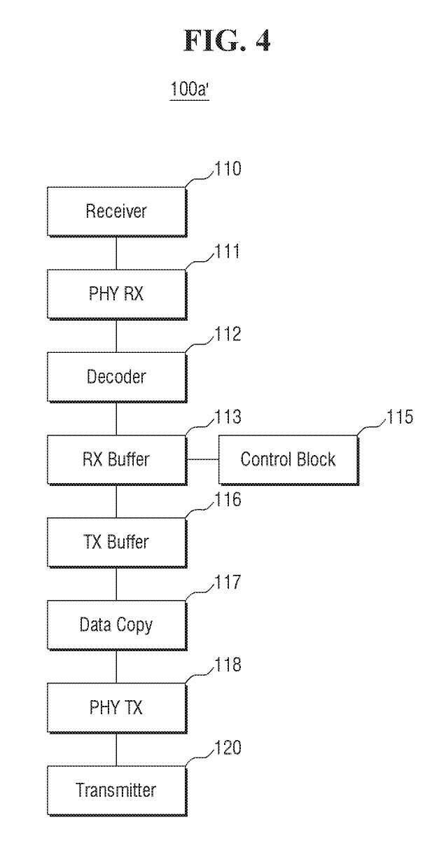

FIG. 3 is a schematic block diagram of the splitter unit 100a according to at least one example embodiment of the present inventive concepts. FIG. 4 is a schematic block diagram of a splitter unit 100a′ according to some example embodiments of the present inventive concepts.

Referring to FIG, 3, the first splitter unit 100a includes a receiver 110 which receives high-volume, high-speed data (e.g., the first data D1 and the second data D2). The high-volume, high-speed data received by the receiver 110 is stored as packets in a receiver buffer 113. A control block 115 sets the size of the receiver buffer 113 to a size that can synchronize a plurality of packets (e.g., thousands of packets). That is, the control block 115 can set the size of the receiver buffer 113 to a desired size in accordance with a design parameter that is configurable and may be determined based on empirical studies. A transmitter buffer 116 receives synchronized data from the receiver buffer 113, and a data copy unit 117 copies the data stored in the transmitter buffer 116. The coped data is transmitted to each processing node through a transmitter 120.

Referring to FIG. 4, more specifically, a receiver 110 of the splitter unit 100a′ receives high-volume, high-speed data (e.g., the first data D1 and the second data D2), a physical layer (PHY) receiver 111 converts the received high-volume, high-speed data, e.g., serial data included in a serial signal, into parallel data included in parallel signals, and then a decoder 112 extracts a plurality of pieces of high-volume, high-speed data as packets. The pieces of high-volume, high-speed data are stored as packets in a receiver buffer 113. A control block 115 sets the desired size of the receiver buffer 113 to a size that can synchronize a plurality of packets (e.g., thousands of packets). The packets stored in the receiver buffer 113 are synchronized to produce synchronized data. A transtmitter buffer 116 receives the synchronized data from the receiver buffer 113, and a data copy unit 117 copies the data stored in the transmitter buffer 116. The data (i.e., the parallel signal) copied by the data copy unit 117 is converted back into a serial signal by a PHY transmitter 118. The copied data (i.e., the serial signal) is transmitted to each processing node through a transmitter 120.

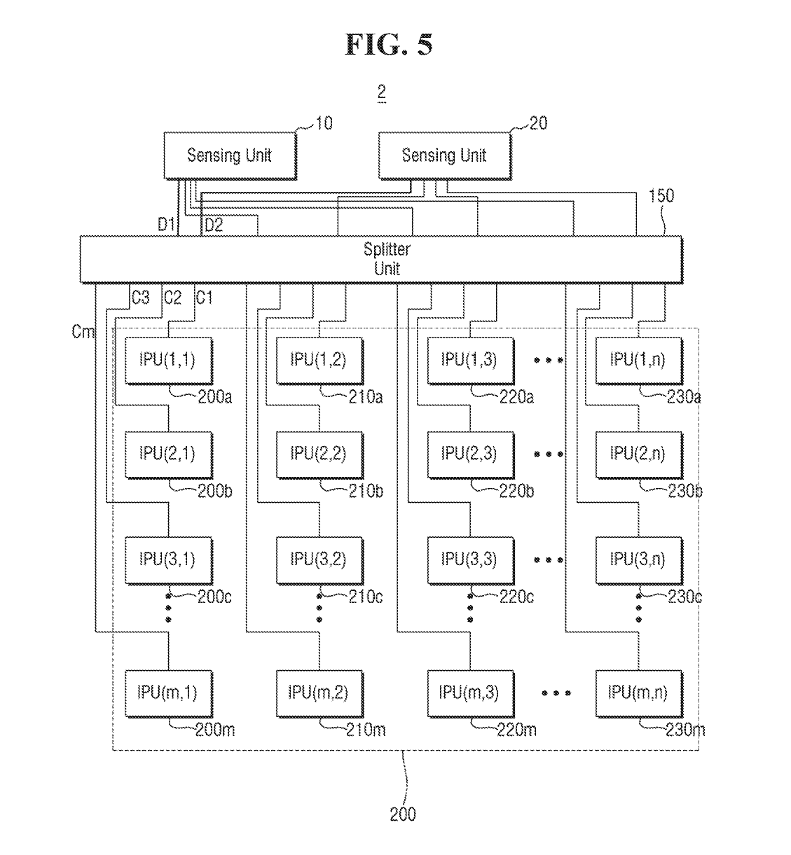

FIG. 5 is a block diagram of a data processing apparatus 2 according to some example embodiments of the present inventive concepts.

Referring to FIG. 5, the data processing apparatus 2 includes a first sensing unit 10, a second sensing unit 20, a splitter unit 150, and a processing unit array 200.

The first sensing unit 10, the second sensing unit 20, and the processing unit array 200 are substantially identical to those described above, and thus a description thereof is omitted.

The splitter unit 150 may receive and synchronize a plurality of pieces of data and output m (where m is a natural number of 2 or more) pieces of copied data in parallel by copying the synchronized pieces of data. In particular, the splitter unit 150 may freely perform data mapping on a plurality of processing nodes included in the processing unit array 200. That is, the splitter unit 150 may transmit a particular piece (e.g., DD1) of copied data to a particular one (e.g., 210a) of the processing nodes such that the particular one of the processing nodes can process the received piece of copied data.

The splitter unit 150 may receive first data D1 from the first sensing unit 10 and second data D2 from the second sensing unit 20 and may synchronize the first data D1 and the second data D2. Since the first data D1 and the second data D2 have a time difference, the splitter unit 150 may synchronize the first data D1 and the second data D2 using a reference clock, thereby generating first synchronized data SD1. The splitter unit 150 may generate in pieces of copied data C1 through Cm by copying the first synchronized data SD1. The m pieces of copied data C1 through Cm all include the same information.

The splitter unit 150 may generate m pieces of copied data including information corresponding to first partial data DD1, m pieces of copied data including information corresponding to second partial data DD2, and pieces of copied data including information corresponding to third partial data DD3, etc. The copied data generated in this way may be provided to the processing unit array 200 and processed by each processing node of the processing unit array 200.

A plurality of processing nodes of the processing unit array 200 arranged in a column direction (i.e., a vertical direction) may receive the same data. Then, each of the processing nodes may process 1/m^{th} of the received data. In other words, each of the processing nodes may process a different 1/m^{th} piece of the received data. Each of a plurality of processing nodes arranged in a row direction (i.e., a horizontal direction) of the processing unit array 200 may receive and process partial data. Here, the processing nodes arranged in the column direction (the vertical direction) of the processing unit array 200 may perform data processing by employing different, separate algorithms or the same algorithm.

The splitter unit 150 may include the elements described above with reference to FIG. 3 or 4.

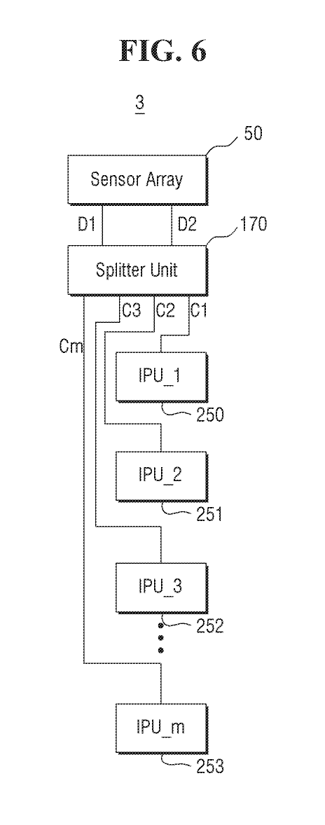

FIG. 6 is a block diagram of a data processing apparatus 3 according to some example embodiments of the present inventive concepts.

Referring to FIG. 6, the data processing apparatus 3 includes a sensor array 50, a splitter unit 170, and first through m^{th} processing units 250 through 253.

The sensor array 50 may include a plurality of sensors, such as first sensor S1 and a second sensor S2, that each generate data. For example, the first sensor S1 may generate first data D1 and the second sensor S2 may genera e second data D2, etc.

The splitter unit 170 may receive and synchronize two or more of the generated data, e.g., first data D1 and second data D2, and generate and output first through m^{th} pieces of copied data C1 through Cm by copying the synchronized data In times.

The first through m^{th} processing units 250 through 253 may be connected to the splitter unit 170 by m output buses and may receive the first through m^{th} pieces of copied data C1 through Cm in parallel from the splitter unit 170 through the m output buses.

The first through m^{th} processing units 250 through 253 may respectively process the first through m^{th} pieces of copied data C1 through Cm received in parallel.

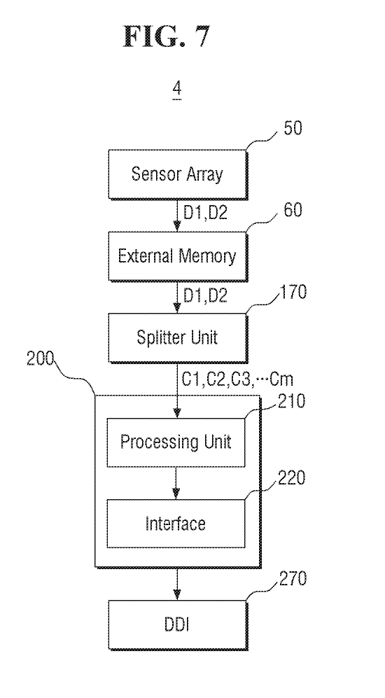

FIG. 7 is a block diagram of a data processing apparatus 4 according to some example embodiments of the present inventive concepts.

Referring to FIG. 7, the data processing apparatus 4 includes a sensor array 50, an external memory 60, a splitter unit 170, a processing unit array 200, and a display driver IC (DDI) 270.

The sensor array 50 may include a plurality of sensors, such as a first sensor S1 and a second sensor S2, etc. The first sensor S1 may generate first data D1 and the second sensor S2 may generate second data D2, etc.

The external memory 60 may store the first data D1 and the second data D2 to be transmitted to the splitter unit 170. In at least one example embodiment of the present inventive concepts, the external memory 60 may include, for example, a nonvolatile memory device, but is not limited thereto and may include volatile memory devices as well. Examples of the nonvolatile memory device may include, but not limited to, a NAND flash device, a NOR flash device, a magnetic random access memory (MRAM), a phase-change random access memory (PRAM), a resistive random access memory (RRAM), etc.

In at least one example embodiment of the present inventive concepts, the external memory 60 can be modified to be a hard disk drive, a magnetic memory device, etc.

The splitter unit 170 may receive and synchronize the plurality of data, e.g., first data D1 and second data D2, and generate and output first through m^{th} pieces of copied data C1 through Cm by copying the synchronized data.

The processing unit array 200 may include a processing unit 210 and an interface 220. The processing unit 210 may include a plurality of processing nodes. The processing unit 210 may receive the first through m^{th} pieces of copied data C1 through Cm from the splitter unit 170 and process the first through m^{th} pieces of copied data C1 through Cm in parallel.

The interface 220 may provide the data processing result of the processing unit 210 to the DDI 270.

In at least one example embodiment of the present inventive concepts, the interface 220 may include, but is not limited to, HS/Link.

The DDT 270 may include a frame buffer FB, a driver D, etc. The frame buffer FB may be used to buffer image data. Accordingly, the frame buffer FB may include a non-transitory storage device for storing the image data.

In at least one example embodiment of the present inventive concepts, the frame buffer FB may he implemented as a memory device, etc. In particular, in some of the example embodiments of the present inventive concepts, the frame buffer FB may be implemented as a static random access memory (SRAM). However, the present inventive concepts are not limited thereto, and the implementation form of the frame buffer FB can be changed as desired.

In other example embodiments of the present inventive concepts, the frame buffer FB may be implemented as another type of memory device such as a dynamic random access memory (DRAM), an MRAM, a RRAM, a PRAM, etc.

The driver D may receive the image data from the frame buffer FB, generate an image signal using the image data, and then provide the image signal to an output panel. In at least one example embodiment of the present inventive concepts, the image data provided by the frame buffer FB may include, e.g., digital data, and the image signal output from the driver D may include, e.g., an analog signal.

In at least one example embodiment of the present inventive concepts, the driver D may include a gate driver GD and a source driver SD.

The gate driver D may be controlled by a timing controller TC to sequentially provide gate driving signals to the output panel through gate lines. In addition, the source driver SD may be controlled by the timing controller TC to provide the image signal to the output panel through a source line whenever the gate lines are selected sequentially.

The output panel may include a plurality of pixels. A plurality of gate lines and a plurality of source lines may be arranged in a matrix to intersect each other in the output panel, and a pixel may be defined at each intersection of a gate line and a data line. In at least one example embodiment of the present inventive concepts, each pixel may consist of a plurality of dots (e.g., RGB).

The timing controller TC may control the source driver SD and the gate driver GD. The timing controller TC may receive a plurality of control signals and/or a plurality of data signals from an external system. The timing controller TC may generate a gate control signal and/or a source control signal in response to the control signals and/or the data signals and output the gate control signal to the gate driver GD and/or the source control signal to the source driver SD.

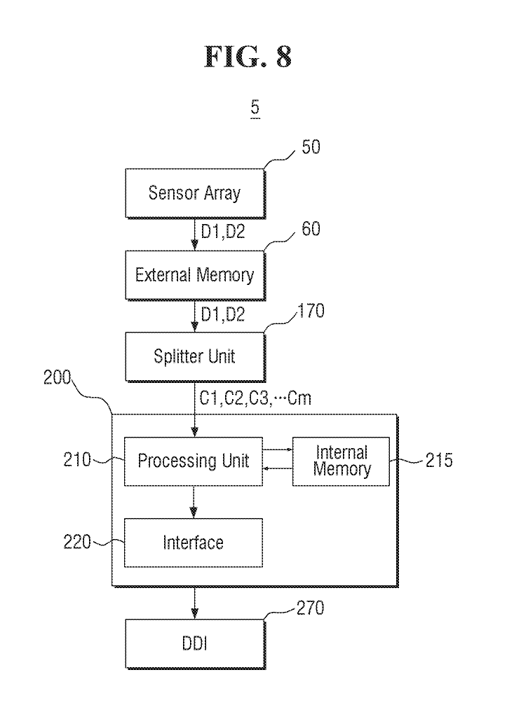

FIG. 8 is a block diagram of a data processing apparatus 5 according to some example embodiments of the present inventive concepts.

Referring to FIG. 8, the data processing apparatus 5 includes a sensor array 50, an external memory 60, a splitter unit 170, a processing unit array 200, and a DDI 270.

The sensor array 50, the external memory 60, the splitter unit 170, and the DDI 270 are substantially identical to those of the data processing apparatus 4 described above, and thus a description thereof is omitted.

The processing unit array 200 of the data processing apparatus 5 may include a processing unit 210, an internal memory 215, and an interface 220.

The processing unit 210 may include a plurality of processing nodes. The processing unit 210 may receive first through m^{th} pieces of copied data C1 through Cm from the splitter unit 170 and process the first through m^{th} pieces of copied data C1 through Cm in parallel.

The data processing result of the processing unit 210 may be stored in the internal memory 215. The processing unit 210 may include a plurality of processing nodes arranged in an m×n matrix. The processing unit 210 may store the processing result of each processing node in the internal memory 215 and complete parallel data processing in a distributed manner using the stored processing results.

The internal memory 215 may include a nonvolatile memory, but is not limited thereto. Examples of the nonvolatile memory may include, but not limited to, a NAND flash device, a NOR flash device, an MRAM device, a PRAM device, and an RRAM device, etc.

The interface 220 may provide the data processing result of the processing unit 210 to the DDI 270.

In at least one example embodiment of the present inventive concepts, the interface 220 may include, but is not limited to, HS/Link.

The DDI 270 may include a frame buffer FB, a driver D, etc. The frame buffer FB may be used to buffer image data. Accordingly, the frame buffer FB may include a storage device for storing the image data.

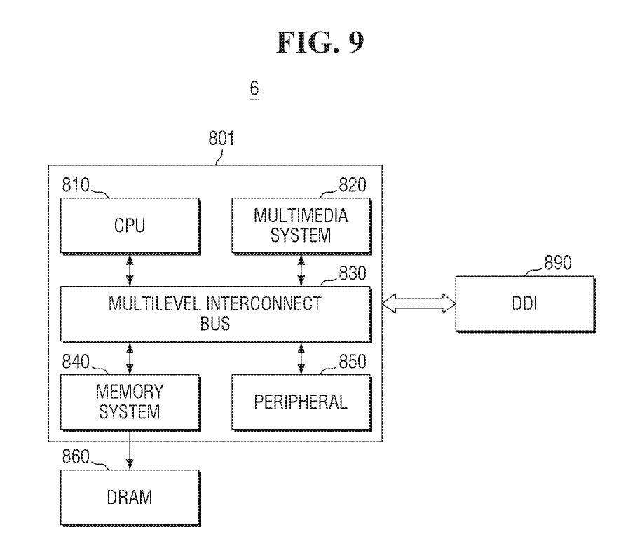

FIG. 9 is a block diagram of a system-on-chip (SoC) system 6 employing a data processing apparatus according to at least one example embodiment of the present inventive concepts.

Referring to FIG. 19, the SoC system 6 includes an application processor 801, a DRAM 860, and a DDI 890.

The application processor 801 may include a central processing unit (CPU) 810, a multimedia system 820, a bus 830, a memory system 840, and a peripheral circuit 850.

The CPU 810 may perform operations needed to drive the SoC system 6. In at least one example embodiment of the present inventive, the CPU 810 may be configured as a multi-processor and/or multi-core environment.

The multimedia system 820 may be used to perform various multimedia functions in the SoC system 6. The multimedia system 820 may include a 3D engine module, a video codec, a display system, a camera system, and a post-processor.

The bus 830 may be used for data communication among the CPU 810, the multimedia system 820, the memory system 840 and the peripheral circuit 850. In at least one example embodiment of the present inventive concepts, the bus 830 may have a multilayer structure. Specifically, the bus 830 may be, but is not limited to, a multilayer advanced high-performance bus (AHB) or a muitilayer advanced extensible interface (AXI).

The memory system 840 may provide an environment needed for the application processor 801 to be connected to an external memory (e.g., the DRAM 860) and may operate at high speed. In at least one example embodiment of the present inventive concepts, the memory system 840 may include a controller (e.g., a DRAM controller) for controlling the external memory (e.g., the DRAM 860).

The peripheral circuit 850 may provide an environment needed for the SoC system 6 to smoothly connect to an external device (e.g., a mainboard, etc.). Accordingly, the peripheral circuit 850 may include various interfaces that enable the external device to connect to the SoC system 6 in order to be compatible with the SoC system 6.

The DRAM 860 may function as a working memory needed for the operation of the application processor 801. In at least one example embodiment of the present inventive concepts, the DRAM 860 may be placed outside the application processor 801 as illustrated in FIG. 9, but is not limited thereto. Specifically, the DRAM 860 may be packaged with the application processor 801 in the form of package on package (PoP).

In at least one example embodiment of the present inventive concepts, the data processing result of any one of the data processing apparatuses according to at least one of the above-described example embodiments of the present inventive concepts may be stored in the DRAM 860.

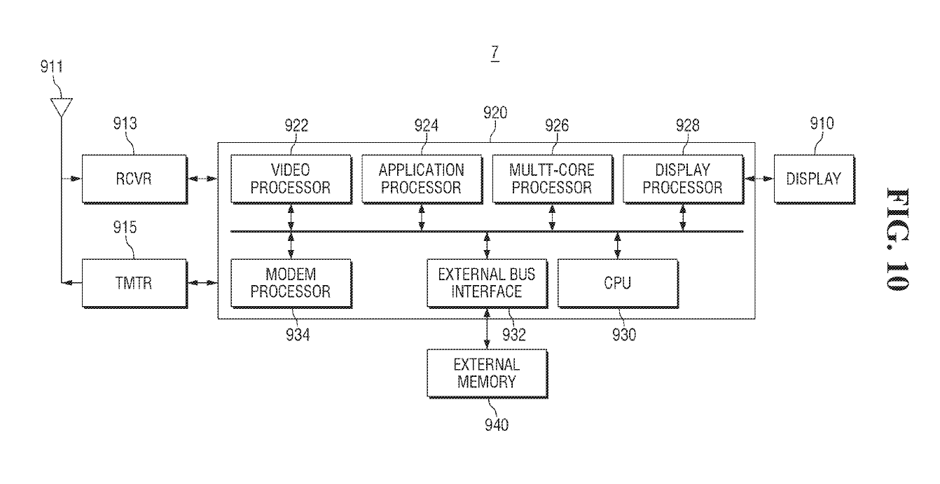

FIG. 10 is a block diagram of a wireless communication device 7 employing a data processing apparatus according to at least one example embodiment of the present inventive concepts.

Referring to FIG. 10, the wireless communication device 7 may be a cellular phone, a smartphone terminal, a tablet, a handset, a personal digital assistant (PDA), a laptop computer, a video game unit, a wearable device, an Internet of Things (IoT) device, and/or some other computing device that is capable of performing wireless communication.

The device 7 may use Code Division Multiple Access (CDMA), Time Division Multiple Access (TDMA) such as Global System for Mobile communications (GSM), WiFi, Bluetooth, and/or some other wireless communication standard.

The device 7 may provide bidirectional communication via a receive path and a transmit path. On the receive path, signals transmitted by one or more base stations may be received by an antenna 911 and provided to a receiver (RCVR) 913. The RCVR 913 conditions and digitizes the received signal and provides samples to a digital section 920 for further processing. On the transmit path, a transmitter (TMTR) 915 receives data transmitted from the digital section 920, processes and conditions the data, generates a modulated signal, and transmits the modulated signal to one or more base stations via the antenna 911.

The digital section 920 may be implemented with one or more digital signal processors (DSPs), microprocessors, reduced instruction set computers (RISCs), complex instruction set computers (CISCs), etc. In addition, the digital section 920 may be fabricated on one or more ASICs or some other type of ICs.

The digital section 920 may include various processing and interface units such as, for example, a modem processor 934, a video processor 922, an application processor 924, a display processor 928, a multi-core processor 926, a CPU 930, and an external bus interface 932.

The modem processor 934, the video processor 922, the application processor 924, the display processor 928, the multi-core processor 926, the CPU 930, and the external bus interface 932 may be connected to each other by bus as illustrated in the drawing.

The video processor 922 may process graphics applications. Generally, the video processor 922 may include any number of processing units or modules for any set of graphics operations.

Certain portions of the video processor 922 may be implemented as hardware, or firmware and/or software combined with hardware. For example, a control unit may be implemented as firmware and/or software modules (e.g., procedures, functions, etc.) that cause at least one processor and/or processing device to perform the functions described above. The firmware and/or software code (e.g., computer readable instructions) may be stored in memory and executed by at least one processor (e.g., the multi-core processor 926), thereby transforming the at least one processor into a special purpose processor. The memory may be implemented inside or outside the processor.

The video processor 922 may implement a software interface such as Open Graphics Library (OpenGL), Direct3D, etc.

The CPU 930 may execute a series of graphics processing operations, together with the video processor 922.

The multi-core processor 926 may include two or more processing cores. The multi-core processor 926 may allocate a workload to be processed to the two or more cores according to the processing workload assigned to the multi-core processor 926 such that the two or more cores process the workload simultaneously.

The display processor 928 may process an image, which is to be displayed on the display 910, in various ways.

According to at least one example embodiment of the present inventive concepts, at least one of the application processor 924 and the display processor 928 may employ the configuration of any one of the data processing apparatuses above-described example embodiments of the present inventive concepts.

The modern processor 934 may perform various processing operations related to communicate within the digital section 920.

The external bus interface 932 may be connected to an external memory 940.

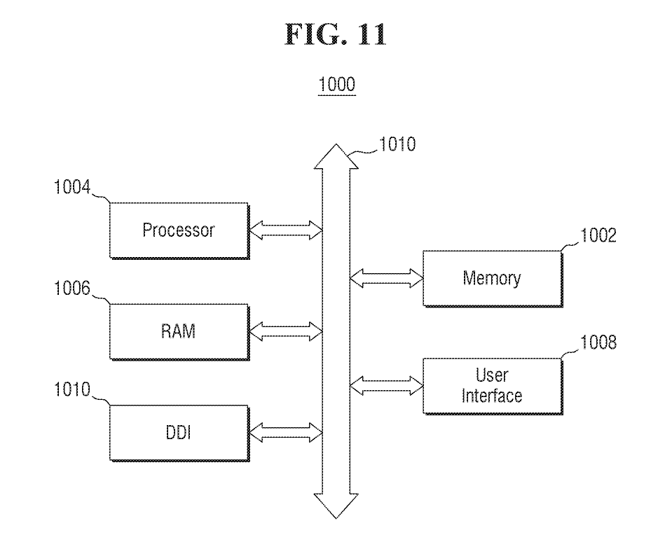

FIG. 11 is a block diagram of an electronic system 1000 including a data processing apparatus according to at least one example embodiment of the present inventive concepts.

Referring to FIG. 11, the electronic system 1000 may include a memory system 1002, a processor 1004, a RAM 1006, a user interface 1008, and a DDI 1010.

The memory system 1002, the processor 1004, the RAM 1006, the user interface 1008, and the DDI 1010 may perform data communication with each other through a bus 1010.

The processor 1004 may execute a program including computer readable instructions that cause the processor 1004 to control the electronic system 1000. The processor 1004 may include at least any one of a microprocessor, a digital signal processor, a microcontroller and logic devices capable of performing similar functions to those of a microprocessor, a digital signal processor, a microcontroller, etc.

The RAM 1006 may be used as a working memory of the processor 1004. The RAM 1006 may be configured as a volatile memory such as a DRAM. The processor 1004 and the RAM 1006 may he packaged into one semiconductor device or a semiconductor package.

The user interface 1008 may be used to input or output data to or from the electronic system 1000. Examples of the user interface 1008 may include a keypad, a keyboard, an image sensor and a display device.

The memory system 1002 may store code for the operation of the processor 1004, data processed by the processor 1004, or data input from an external source. The memory system 1002 may include a controller for its operation. The memory system may further include an error correction block. The error correction block may be configured to detect and correct errors in data stored in the memory system 1002 using error correction code (ECC).

In an information processing system such as a mobile device or a desktop computer, a flash memory may be installed as the memory system 1002. The flash memory may be configured as a solid state driver (SSD) in this case, the electronic system 1000 can stably store high-volume data in the flash memory.

The memory system 102 may be integrated into one semiconductor device. In an example, the memory system 1002 may be integrated into one semiconductor device to form a memory card. For example, the memory system 1002 may be integrated into one semiconductor device to form a memory card such as a personal computer memory card international association (PCMCIA) card, a compact flash (CF) card, a smart media card (SM, SMC), a memory stick, a multimedia card (MMC, RS-MMC, MMCmicro), a secure digital (SD) card (SI), miniSD, microSD, SDHC), or a universal flash storage (UFS), etc.

In at least one example embodiment of the present inventive concepts, the DDI 1010 may employ the configuration of any one of the data processing apparatuses according to at least one of the above-described example embodiments of the present inventive concepts.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing devices) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should he considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

1. A data processing apparatus comprising:
a first sensor configured to generate first data about a target;
a second sensor configured to generate second data about the target, the second data having a time difference from the first data;
a splitter configured to receive and synchronize the first data and the second data, and output m pieces of copied data by copying the synchronized data; and
a processor configured to receive and process any one of the m pieces of copied data, and m is a natural number of 2 or more.

2. The apparatus of claim 1, further comprising:
m output buses connecting the splitter and the processor; and
wherein the m pieces of copied data are transmitted simultaneously through the m output buses.

3. The apparatus of claim 1, wherein the processor is configured to process data corresponding to 1/m-th of any one of the m pieces of copied data.

4. The apparatus of claim 1, wherein each of the first data and the second data comprises information corresponding to any one of n regions into which the target is divided, where n is a natural number of 2 or more.

5. The apparatus of claim 4, wherein the first data and the second data comprise information corresponding to a same region of the target.

6. The apparatus of claim 1, wherein
the splitter comprises a receiver buffer; and
the receiver buffer is configured to store the first data and the second data, and synchronize the stored first data and the stored second data.

7. The apparatus of claim 6, wherein the receiver buffer is configured to store the first data and the second data as packets.

8. The apparatus of claim 7, wherein the splitter further comprises a control block configured to set a size of the receiver buffer.

9. The apparatus of claim 8, wherein the splitter further comprises a transmitter buffer configured to store the synchronized data.

10-16. (canceled)

17. A data processing apparatus comprising:
a plurality of sensors;
a plurality of splitters configured to
receive first through n-th pieces of partial data from the plurality of sensors, each piece of the partial data comprising a plurality of data packets,
generate first through n-th pieces of synchronized data by synchronizing the plurality of data packets, and
generate first through m-th pieces of copied data for each of the first through n-th pieces of synchronized data; and
a processor array including an m×n matrix of processors, the processing array configured to receive the first through m-th pieces of copied data in parallel and process the first through m-th pieces of copied data; and
wherein n is a natural number of 2 or more and m is a natural number of 2 or more.

18. The apparatus of claim 17, wherein each of the first through n-th pieces of partial data comprises information corresponding to a boundary region which overlaps a boundary region of another piece of the partial data.

19. The apparatus of claim 17, wherein m processors are arranged in a first column of the processor array and are each configured to receive any one of the first through m-th pieces of copied data.

20. The apparatus of claim 19, wherein the first through m-th pieces of copied data comprise the same information.

21. The apparatus of claim 19, wherein each of the m processors are configured to process any one of the first through m-th pieces of copied data.

22. The apparatus of claim 19, wherein n processors are arranged in a first row of the processor array and are each configured to receive any one of the first through n-th pieces of partial data.

23. The apparatus of claim 21, wherein the first through n-th pieces of partial data comprise different information.

24-37. (canceled)

38. A data processing apparatus comprising:
a plurality of image sensors each configured to capture image data of at least one region of a substrate;
a plurality of splitters each configured to
receive the captured image data from each of the plurality of image sensors,
synchronize each of the plurality of received image data into a single synchronized image,
split the synchronized image data into a plurality of split image data, the split image data including a portion of the synchronized image data,
generate a plurality of sets of copied image data, each of the sets of copied image data including copies of each of the plurality of split image data, and
output the plurality of sets of copied image data in parallel; and
a plurality of processors each configured to
receive at least one of the output plurality of sets of copied image data, and
process the received set of copied image data.

39. The data processing apparatus of claim 38, wherein
the substrate is divided into a plurality of regions;
each of the captured image data includes image data related to a border region between at least two regions of the divided substrate; and
the processing of the received copied image data includes detecting defects in the substrate by analyzing the received set of copied image data.

40. The data processing apparatus of claim 38, wherein
the plurality of processors is a processor array arranged in a first number of rows and a second number of columns;
the splitting of the synchronized image data includes splitting the synchronized image data into a number of split image data corresponding to the first number of rows; and
the copying of the plurality of the split image data includes copying the split image data a number of times corresponding to the second number of columns.

41. The data processing apparatus of claim 38, wherein each of the plurality of image sensors is configured to:
use separate image capturing settings; and
capture image data of a same region of the plurality of regions at separate times.
